(19) United States
(12) Patent Application Publication
(10) Pub. No.: US 2016/0197729 A1
(43) Pub. Date: Jul. 7, 2016

(54) LOCATION AWARE CRYPTOGRAPHY

(71) Applicant: Advanced Micro Devices, Inc., Sunnyvale, CA (US)

(72) Inventor: Nicholas T. Jones, Austin, TX (US)

(21) Appl. No.: 14/589,944

(22) Filed: Jan. 5, 2015

(51) Int. Cl. H04L 9/32; G06F 12/14

(52) U.S. Cl. CPC H04L 9/3242; H04L 9/3231; G06F 12/1408; G06F 2212/1052

(57) ABSTRACT

A method of decrypting encrypted data in a device may include generating a first key based on location information indicating a present location of the device, combining the first key with at least a second key to generate a combined key, and decrypting the encrypted data based on the combined key.

### TECHNICAL FIELD

This disclosure relates to the field of cryptography and, in particular, to cryptography using a location-based authentication key.

### BACKGROUND

In a modern computing system, data may often be encrypted to secure it from unauthorized viewing or modification. Encryption of the data deters a user from comprehending or interpreting the encrypted data unless proper authorization, in the form of one or more keys, is provided for decrypting the data. Encryption methods generally utilize a mathematical algorithm to transform legible data (plaintext) into its encrypted form (ciphertext), that cannot be comprehended without the knowledge and use of a key to decrypt the encrypted data or significant computational effort.

Some computing systems implementing multi-factor authentication for cryptography may request multiple authentication factors, from which one or more keys can be generated before the encrypted data can be decrypted. One type of factor that may be used for generating a key is a password, which is a secret word or string of characters that is ideally known only to an authorized user or group of users. In many systems, a password may be used in combination with one or more other factors, such as biometric information or a possession factor, such as a physical key or memory card.

Encryption based on one or more passwords may be susceptible to brute force attacks, particularly since the complexity of a password may be limited by the memorization capabilities of the user. The requirement of multiple factors reduces the likelihood that an unauthorized user will be able to obtain access to the data; however, other factors may be stolen or otherwise falsified, allowing an unauthorized user to access the encrypted data.

### BRIEF DESCRIPTION OF THE DRAWINGS

The present disclosure is illustrated by way of example, and not by way of limitation, in the figures of the accompanying drawings.

FIG. 1 illustrates an embodiment of a computing system.

FIG. 2 illustrates an embodiment of an authentication system.

FIG. 3 is a flow diagram illustrating a cryptographic process with location-based authentication, according to one embodiment.

### DETAILED DESCRIPTION

The following description sets forth numerous specific details such as examples of specific systems, components, methods, and so forth, in order to provide a good understanding of the embodiments. It will be apparent to one skilled in the art, however, that at least some embodiments may be practiced without these specific details. In other instances, well-known components or methods are not described in detail or are presented in a simple block diagram format in order to avoid unnecessarily obscuring the embodiments. Thus, the specific details set forth are merely exemplary. Particular implementations may vary from these exemplary details and still be contemplated to be within the spirit and scope of the embodiments.

Generally, the level of security provided by a conventional multi-factor authentication scheme for decrypting data is not affected by the geographic location of the device in which it is implemented. Accordingly, the physical theft and removal of the device from an approved location does not render the data any more protected than it originally was.

An increasing number of computing devices include location detection functionality, by means of a location detection module, such as a global positioning system (GPS) locator, cell tower triangulation module, or WiFi or network location detection module. One embodiment of a computing device may utilize such location information as a factor for authenticating a user in a multi-factor authentication scheme for decrypting data. Data to be protected from unauthorized access is encrypted and decrypted using a password that is combined with a salted and hashed location value provided by the location detection module.

This location-based authentication scheme enhances the security of the encrypted data transparently to a user who is accessing the data while the device is in an approved geographic location. For example, a user may only need to access secured data at one of a few locations, such as their home or office. For such a user, the location-based factor adds security without requiring the user to memorize another password or carry an additional possession factor, such as a smart card or dongle. If the computing device is then removed from the approved locations, the location-based factor ensures that the encrypted data cannot be accessed even if the password is compromised, thus protecting the data from physical theft of the device.

The location-based encryption is also difficult to circumvent due to the difficulty of spoofing GPS signals or other location detection methods. If the device is in an unauthorized geographic location, the decryption would fail even if the user password is compromised by theft or by brute force methods.

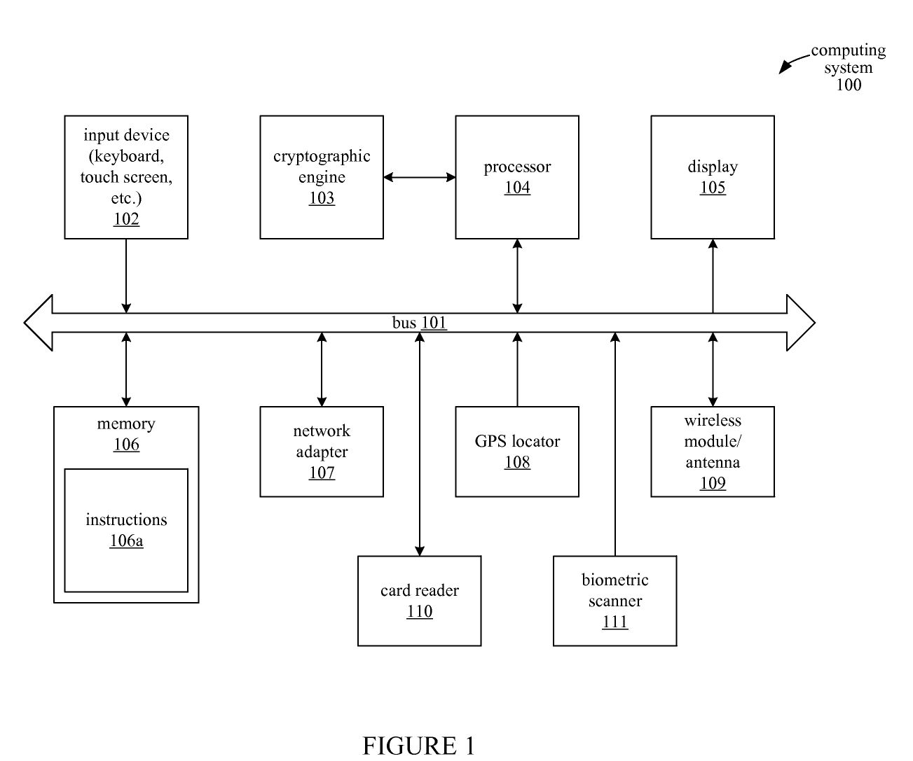

FIG. 1 illustrates an embodiment of a computing system 100 which may implement a location-based authentication and encryption scheme. In general, the computing system 100 may be embodied as any of a number of different types of devices, including but not limited to a laptop or desktop computer, mobile phone, server, etc. The computing system 100 includes a number of components 102-111 that can communicate with each other through a bus 101. In computing system 100, each of the components 102-111 is capable of communicating with any of the other components 102-111 either directly through the bus 101, or via one or more of the other components 102-111. The components 101-111 in computing system 100 are contained within a single physical casing, such as a laptop or desktop chassis, or a mobile phone casing. In alternative embodiments, some of the components of computing system 100 may be embodied as peripheral devices such that the entire computing system 100 does not reside within a single physical casing.

Computing system 100 includes a processor 104 that is configured to receive and execute instructions 106a that are stored in the memory subsystem 106. The processor 104 is connected with a cryptographic engine 103. The processor 104 and the cryptographic engine 103 are part of a processor subsystem. The cryptographic engine 103 is implemented in a coprocessor on the same die as the processor 104. In an alternative embodiment, the cryptographic engine may be located on a separate die from the processor 104, or may be implemented in a separate module.

The cryptographic engine 103 includes hardware for performing cryptographic operations on data. As such, the cryptographic engine 103 is capable of encrypting and decrypting data. The cryptographic engine 103 is further capable of encrypting and decrypting data in accord with one or more National Institute of Standards and Technology (NIST) approved encryption standards, such as the Advanced Encryption Standard (AES).

Memory subsystem 106 includes memory devices used by the computing system 100, such as random-access memory (RAM) modules, read-only memory (ROM) modules, hard disks, and other non-transitory computer-readable media. The instructions 106a may direct the processor 104 to perform the operations for implementing the location-based authentication and encryption scheme.

The computing system 100 also includes user interface devices for receiving information from or providing information to a user. Specifically, the computing system 100 includes an input device 102, such as a keyboard, mouse, touch-screen, or other device for receiving information from the user. The computing system 100 displays information to the user via a display 105, such as a monitor, light-emitting diode (LED) display, liquid crystal display, or other output device.

The computing system 100 also includes other input devices, such as a card reader 110 and a biometric scanner 111. The card reader 110 includes a slot for inserting a memory card, such as a smart card. The biometric scanner 111 is capable of measuring some physical feature of a user, and converting the measurement into biometric data for authenticating the user. The biometric scanner 111 may include a fingerprint scanner, retina scanner, or other device capable of measuring a physical feature of the user.

Computing system 100 additionally includes a number of components that may be used for location detection. The global positioning system (GPS) locator 108 is a dedicated location detection module that can detect its own location based on received GPS signals. Other components, such as network adapter 107 and wireless module 109 may be primarily used for transmitting and receiving data over a wired and wireless network, respectively, but are also capable of detecting geographic location. For example, the network adapter 107 may be used for detecting its own location by identifying other hardware devices in a network topology to which it is connected. Detection of a location based on the network topology could be performed by software running on the processor based on information provided by the network device. When the identified hardware devices have known geographic locations, the geographic location of the network adapter 107 can be determined. A wireless module 109 is capable of detecting location by triangulation using signals received from transmitters at known locations, such as cell towers or wireless routers. The wireless module 109 may also detect location based on other characteristics of received signals, such as signal strengths.

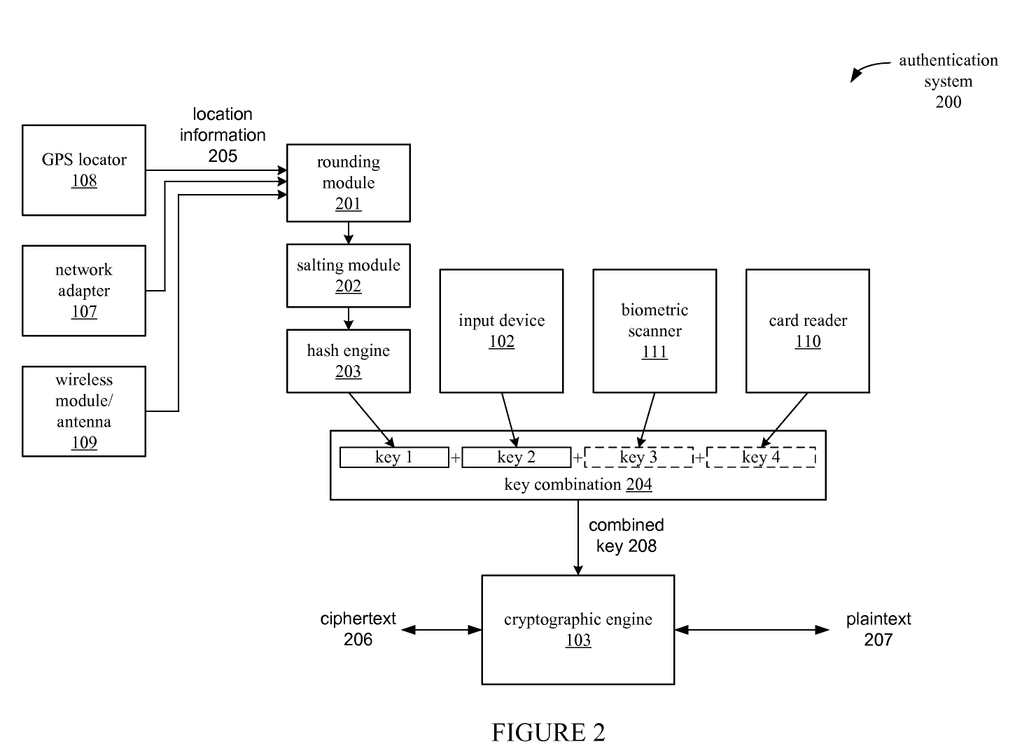

FIG. 2 is a block diagram illustrating an authentication system 200 that is implemented in the computing system 100 for performing location-based decryption of encrypted data. The modules 201, 202, 203, 204 as illustrated in FIG. 2 are separate hardware modules, which may be implemented using dedicated circuits or programmable logic. In alternative embodiments, these modules may be implemented using the processor 104 and instructions 106a. For example, the instructions 106a may direct the processor 104 to perform the operations of the different modules 201-204, with information (such as the location information 205 and combined key 208) transmitted between modules over the bus 101. In alternative embodiments, some or all of the modules may reside together on a single integrated circuit chip to deter access to the signals.

In the authentication system 200, the GPS locator 108 determines the location information 205, which includes a latitude value and a longitude value indicating a present geographic location of the computing system 100. In some embodiments, the location information 205 may also include other data, such as elevation or orientation. The location information 205 generated by the GPS locator 108 is difficult to falsify. An attacker could potentially jam the receiver of the GPS locator 108 to generate false location information; however, this type of attack would require significantly more effort than compromising a user's password by brute force methods.

In cases where the GPS locator 108 or a GPS signal is unavailable, the system 200 responds by determining the location information 205 using a backup location detection method, such as a network awareness method or cell or wireless signal triangulation.

The network adapter 107 is used to determine the location information 205 by analyzing the topology of a network to which the network adapter 108 is connected. For instance, the network adapter 108 determines identifying information, such as a media access control (MAC) address or internet protocol (IP) address, for one or more other devices in a network to which the network adapter 108 is connected. The location information 205 indicating the geographic location of the computing system 100 can then be determined using known locations of the identified devices or other network hardware that are discovered in the network topology.

This location information 205 determined using network awareness is also represented as a latitude and longitude, so that it can be used in the same manner as location information determined by the GPS locator 108. Even if the geographic location as determined by this method is less accurate than the location determined by the GPS locator, the network awareness method may still provide sufficient accuracy since a range of locations is acceptable.

In an alternative embodiment, the location information 205 as determined by the network adapter 107 may include the identifying information (such as a MAC address or IP address) of a nearby device in the network topology. For example, the location information 205 may include the MAC address of the nearest router, so that decryption based on the location information 205 would fail unless the computing system 100 is connected via network adapter 107 to an approved router, such as the user's home or office router. In such an embodiment, the location information 205 may identify a location of the computer system 100 in the network topology that is not necessarily correlated to a geographic location.

In cases where both the GPS locator 108 and the network adapter 107 are not able to determine the location information 205, the wireless module 109 determines the location information 205. The wireless module 109 determines a geographic location of the computing system 100 by performing triangulation based on signals received from other devices having known geographic locations, such as cell towers. The location information 205 of the computing system 100 as determined by the wireless module 109 is also represented as a latitude value and longitude value, so that it can be used in the same manner as location information determined by the GPS locator 108.

As described above, the authentication system 200 uses the GPS locator 108 as the primary method for determining the location information 205, relying on the network adapter 107, and the wireless module 109 as respective backup methods for determining the location information 205 when the GPS locator 108 is unable to do so. In alternative embodiments, the authentication system 200 may use a location detection module other than the GPS locator 108 as the primary location detection method. Furthermore, the order of priority of the backup location detection methods may also differ between different embodiments. Some alternative embodiments may use one location detection method without any backup location detection methods.

In the authentication system 200, the location information 205 is rounded, salted, and hashed to generate a key value to be used for encrypting or decrypting the data to be secured. The computing system includes a rounding module 201, a salting module 202, and a hash engine 203 for performing the rounding, salting, and hashing operations, respectively.

The rounding module 201 is connected to the location detection modules, including GPS locator 108, network adapter 107, and the wireless module 109. The rounding module receives the location information 205 from the location detection module 107, 108, or 109 that generates the location information 205 and performs a rounding operation on the location information 205. This rounding operation selects one or more of the most significant digits of the latitude and longitude values and discards the least significant digits. For example, a latitude value of 37.386646 and a longitude value of −121.998953 may be rounded to 37.387 and −121.999, respectively.

The rounding module can discard a different number of the least significant digits depending on the desired size of the authorized location within which the data can be decrypted. Discarding more of the least significant digits results in a larger authorized location. The rounding module 201 transmits the rounded location values (latitude and longitude) to the salting module 202.

In cryptography, a salt is a random value that is used to modify another value before hashing. The use of a salt value defends against certain types of attacks, such as dictionary and rainbow table attacks.

When an encryption process is being performed, the salting module 202 generates a random salt value and salts the rounded location values. The salting module 202 stores the salt value in a database to be retrieved later when the data is being decrypted. If decryption is being performed, the salting module 202 looks up the salt value that was previously used when encrypting the data. The salt value is looked up in a database that correlates the salt value with the encrypted dataset. In alternative embodiments, the database may correlate the previously used salt value with other values, such as the location or the user's password.

In the authentication system 200, the salting module 202 concatenates the rounded latitude value, the rounded longitude values, and the salt value, generating a salted location value. In alternative embodiments, more than one salt value may be used, or the values may be concatenated in any one of the other possible orders. In an alternative embodiment, the salting module 202 may perform an XOR operation based on the rounded latitude value, the rounded longitude value, and/or the salt value. The salting module 202 provides the salted location value to the hash engine 203.

The hash engine 203 performs a cryptographic hash function, which receives a block of input data, known as a “message” and generates a fixed-size bit string based on the input message. The fixed-size bit string is the cryptographic hash value.

For the cryptographic hash function implemented in the hash engine 203, the computation of the hash value from the input message is relatively easy, while the reverse computation to determine the input message based on its hash value is either very difficult or mathematically infeasible. Furthermore, each different input message results in a different output hash value, with high probability, and finding two different input messages resulting in the same hash value is exceedingly difficult.

The hash engine 203 is configurable to execute any of a number of cryptographic hash functions, such as hash functions from Secure Hash Algorithm family (SHA-1, SHA-2, etc.), or other cryptographic hash families.

The hash engine 203 receives the salted location value from the salting module 202 and executes the cryptographic hash process on the salted location value to generate an output hash value. This output hash value is used as a first key, identified as key 1 in FIG. 2. The key combination module 204 receives key 1 from the hash engine 203.

An additional key, identified as key 2 in FIG. 2, is provided from an input device 102. Input device 102 is a device, such as a keyboard, that allows a user to enter a password or passphrase. The password is received by the input device 102 and transmitted to the key combination module 204 to be combined with key 1. In an alternative embodiment, the key combination module 204 combines the location-based key 1 with a key 2 that is provided from a source other than the input device 102. For example, key 2 may include information provided from a biometric scanner, card reader, dongle, or other device instead of a password from the input device 102.

In the authentication system 200, the key combination module 204 is configurable to receive additional optional keys, including key 3 and key 4. When these additional keys are enabled, the key combination module combines the additional keys 3 and 4 with key 1 and key 2 to generate the combined key 208.

Key 3 is generated based on data collected by a biometric scanner 111. Biometric scanner 111 is a device that measures characteristics of a user's body in order to authenticate the user, such as a fingerprint scanner or a retina scanner. The biometric data collected by the biometric scanner 111 is converted into computer readable data and transmitted to the key combination module 204 as key 3.

Authentication system 200 also includes a card reader 110, which allows the use of a possession factor such as a memory card for authenticating the user. The card reader 110 reads authentication data from the memory card and transmits the data to the key combination module 204 as key 4.

In alternative embodiments, authentication data such as the password, biometric data, or card data may be further processed to generate key 2, key 3, and key 4. Such processing may include salting and/or hashing of the authentication data by the salting module 202 and hash engine 203, for example. In some embodiments, the keys may generated by the cryptographic engine 103 by performing a sequence of cryptographic operations on the received authentication data.

The key combination module 204 receives key 1, key 2, and optionally receives key 3 and key 4. When the authentication system 200 is configured to use key 1 and key 2, the key combination module 204 receives these keys and concatenates them to generate a combined key 208. When the authentication system 200 is configured to use the additional keys 2 and 4, the key combination module 204 combines key 1, key 2, key 3, and key 4 to generate the combined key 208.

In alternative embodiments, the key combination module 204 may concatenate the keys in a different order, or may perform additional operations in order to combine the keys. For example, the key combination module 204 in some embodiments may perform an XOR operation with one or more of the keys as operands. In one embodiment, a key combination method may be chosen to generate an appropriate sized key for use with the cryptographic engine 103.

The combination of keys into a single combined key increases the security of the authentication system. In order to compromise both the location-based key and the password, an attacker would have to jam or falsify the GPS signal while concurrently attacking the password by brute force or other methods.

The cryptographic engine 103 receives the combined key 208 from the key combination module 204. In the authentication system 200, the cryptographic engine 103 is an Advanced Encryption Standard (AES) engine that encrypts the plaintext 207 based on the combined key 208 to generate one or blocks of ciphertext 206, or decrypts one or more blocks of ciphertext 206 based on the combined key 208 to generate the output plaintext 207. The input ciphertext 206 represents the encrypted and secured data that is stored in the memory 106. For instance, the encrypted data may be stored in random access memory (RAM), read only memory (ROM), or on a hard disk of the computer system 100. The cryptographic engine 103 receives the encrypted data from the memory 106 and decrypts it using an AES decryption process. In an alternative embodiment, the cryptographic engine 103 may implement a different encryption and decryption process from AES. For example, other embodiments may utilize authentication methods that support multiple keys such that the keys 1-4 need not be combined prior to beginning the encryption or decryption process.

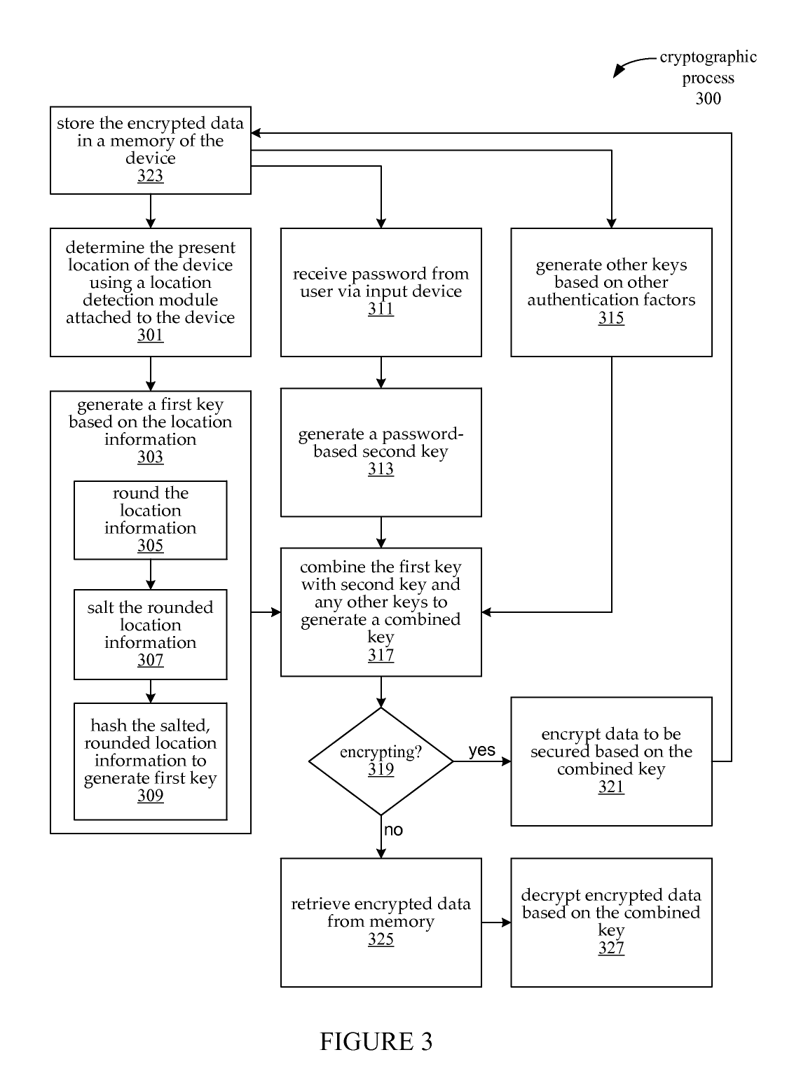

FIG. 3 illustrates an embodiment of a cryptographic process 300 with location-based authentication. The cryptographic process 300 is used to encrypt or decrypt data in a mobile computing system, such as computing system 100. The operations in process 300 are implemented in the computing system 100 by the hardware modules in the authentication system 200. Alternatively, the process 300 may be implemented in the computing system 100 using instructions 106a stored in the memory 106 of the computing system 100. In either case, the operations of process 300 are executed by at least some of the components of the computing system 100, such as the processor 104, cryptographic engine 103, network adapter 107, GPS locator 108, etc.

To perform encryption of the data, the process 300 begins at block 301. At block 301, the GPS locator 108 determines a location of the computing system 100. The GPS locator 108 is attached to the computing system 100 so that the location of the computing system 100 can be treated as being the same as the location of the GPS locator 108. In alternative embodiments, the location of the GPS locator may differ from the location of the computing system by a known amount, such that the location of the computing system can be calculated. The location information 205 may indicate a geographic point at which the computing system is located, or may indicate an area within which the computing system is located.

The location information 205 determined by the GPS locator includes both latitude and longitude values. In an alternative embodiment, the location information 205 may include fewer or more values. For example, the location information 205 may additionally include an elevation value. In an alternative embodiment, the location information 205 may also include other values that can be determined by the GPS locator, such as speed and direction.

Alternatively, the present location of the computing system 100 may be obtained by other methods besides GPS. These alternate location detection methods can be used when the GPS locator is unable to determine the location, such as when the computing system 100 is indoors and unable to receive a GPS signal.

For example, in response to a failure of the GPS locator to determine the location, the computing system 100 may determine the location information 205 by triangulation based on wireless signals from multiple signal sources that are received at the wireless module 109. The computing system 100 may alternatively determine its present location by identifying one or more other devices connected to a network to which the network adapter 107 of the computing system 100 is connected. In one embodiment, the location of the computing system 100 can be determined based on known locations of other devices in the network. For example, if the network adapter 107 is connected to a user's home router, the computing device 100 may be considered as being located at the user's home. From block 301, the process 300 continues at block 303.

At block 303, the computing device 100 generates a first key based on the location information 205 generated at block 301. The computing device 100 generates the first key by performing a sequence of computations on the location information 205. The key generation process of block 303 begins at block 305 and includes blocks 305, 307, and 309.

At block 305, the rounding module 201 of the authentication system 200 implemented in computing system 100 receives the location information 205 from the GPS locator 108. The rounding module 201 rounds the location information 205 by discarding one or more of the least significant digits of each location value (such as latitude or longitude) included in the location information 205, and retaining one or more of the most significant digits of the location values. The rounding module 201 outputs the resulting rounded location information to the salting module. From block 305, the key generation process 303 continues at block 307.

At block 307, the salting module 202 receives the rounded location information. For a cryptographic process 300 that is encrypting data, the salting module 202 generates a random salt value and applies the salt value to the rounded location information. Specifically, the salt value is concatenated with the rounded latitude and longitude values. In alternative embodiments, more than one salt value may be used or the salt value and location values may be concatenated in different orders. The salting module 202 stores the salt value in a memory, such as memory 106, for later retrieval in connection with decrypting the data. The salting module 202 transmits the rounded and salted location information to the hash engine 203. From block 307, the key generation process 303 continues at block 309.

At block 309, the hash engine 203 receives the rounded and salted location information and performs a cryptographic hash process on the rounded and salted location information. The resulting output hash value is used as the first key, key 1. In alternative embodiments, the rounding, salting and hashing operations may be performed in different orders. In other embodiments, the key generation process 303 may include other operations in addition to or instead of the rounding, salting, and hashing operations, such as XOR or bit shifting operations, for example. The first key is transmitted from the hash engine 203 to the key combination module 204. At block 309, the process 303 concludes since the first key has been generated. From block 303, the process 300 continues at block 317.

During the execution of blocks 301-309, the computing system 100 may concurrently execute blocks 311 and 313 to generate a second key based on a user's password. At block 311, the computing system 100 receives the password from the user. The user types the password into an input device 102, such as a keyboard or a touchscreen connected to the computing system 100. From block 311, the process 300 continues at block 313.

At block 313, the computing system 100 generates a second key, key 2, based on the password received at block 311. In the simplest embodiment, the password itself is used as the second key without further modification. In alternative embodiments, various operations may be performed on the received password value, such as XOR operations or bit shift operations. In one embodiment, the password value may be salted and/or hashed similar to the location values. The password-based second key is transmitted to the key combination module 204. From block 313, the process 300 continues at block 317.

During the execution of blocks 301-309 and the blocks 311-313, the computing system may concurrently execute operations associated with block 315 to generate keys based on other authentication factors. These other authentication factors may include possession factors, such as a smart card, or inherence factors, such as biometric data.

In the authentication system 200 implemented in computing system 100, the biometric scanner 111, such as a finger print scanner or retina scanner, is used to collect biometric data by measuring or imaging some characteristic of the user's body. The biometric data collected using the biometric scanner 111 is used as a third key, key 3, without further modification. In an alternative embodiment, the third key may be generated by performing a sequence of various operations to modify the biometric data, such as XOR or bit shift operations. In one embodiment, the biometric data may be salted and/or hashed similar to the location values.

In the authentication system 200, the card reader 110 is used to retrieve authentication data from a memory card. The memory card data is then used as a fourth key, key 4, without further modification. In alternative embodiments, the third key may be generated by performing a sequence including various operations on the memory card data, such as XOR or bit shift operations. In one embodiment, the memory card data may be salted and/or hashed similar to the location values.

The authentication system 200 may be configurable to use any one of a number of possible combinations of the first, second, third, and fourth keys. For example, the authentication system 200 in a first configuration uses only the first and second keys, while in a second configuration uses all four keys. If the third and fourth keys are in use, they are transmitted to the key combination module 204. In alternative embodiments, the third and fourth keys may be generated based on different authentication factors other than biometric and memory card data. Alternative embodiments may also include more than four keys. From block 315, the process 300 continues at block 317.

At block 317, the key combination module 204 receives the first key and second key. If the authentication system 200 is configured to use the third and fourth key, the key combination module 204 also receives the third key and fourth key. In general, the key combination module 204 receives any keys which are enabled according to the configuration of the authentication system 200. The key combination module 204 then combines the received keys by concatenating them in order, such that the first key precedes the second key, which precedes the third key, and so on. In an alternative embodiment, the keys may be concatenated in reverse order, or in some other predefined order. In an alternative embodiment, the key combination module 204 may combine the keys by some method other than concatenation. For example, the key combination module may perform one or more XOR operations or other bitwise operations using the received keys as operands. The combined key 208 that is generated by combining the received keys is transmitted to the cryptographic engine 103. From block 317, the process 300 continues at block 319.

At block 319, if encryption is being performed, the process 300 continues at block 321. Otherwise, if decryption is being performed by the process 300, the process 300 continues at block 325.

For the present encryption process, the process 300 continues at block 321, where the cryptographic engine 103 receives the combined key 208, then encrypts the data to be encrypted using the combined key 208. The cryptographic engine 103 receives the plaintext data 207 and encrypts the data 207 using the combined key 208 in order to generate the ciphertext 206. The cryptographic engine 103 performs an AES encryption process; however, in alternative embodiments, a different encryption standard may be used. From block 321, the process 300 continues at block 323.

At block 323, the encrypted data, including the ciphertext 206 created at block 321, is stored in the memory 106 of the computing system 100. The memory 106 stores the encrypted data until a user requests access to the data.

When a user requests access to the encrypted data, the process 300 is used to generate the keys for decrypting the data and performing the decryption. The process 300 when performing a decryption process executes blocks 301-309 as previously discussed, except that a new salt value is not randomly generated at block 307; instead, the salt value used to encrypt the data is looked up. For example, the salting module 202 may retrieve the previously used salt value from a database that correlates the salt value with the encrypted dataset.

The process 300, when performing decryption, also generates the password-based second key in a similar fashion as for the encryption process, receiving the password from the user via an input device 102 at block 311, and generating the second key based on the received password at block 313. Any other keys, such as biometric or memory card-based keys, that had been used to encrypt the data are recreated at block 315 in similar fashion as for the encryption process. The combined key 208 is then generated at block 317 by the key combination module 204.

At block 319, the process 300 continues to block 325, since decryption is being performed. At block 325, the encrypted data is retrieved from the memory 106 and transmitted to the cryptographic engine 103. From block 325, the process 300 continues at block 327.

At block 327, the cryptographic engine 103 receives the encrypted data from the memory 106 and decrypts the encrypted data using the combined key 208. The decryption is performed using the same cryptographic standard as the encryption of the data, for example, AES. In other embodiments, cryptographic standards other than AES may be used. The decrypted data can then be presented to the authenticated user.

By the operation of process 300, the authentication system 200 implemented in computer system 100 allows a user to secure data by encrypting it with at least one location-based key and at least one other key, such as a password-based key. Subsequently, the secured data can be decrypted and accessed only when a location detection module, such as a GPS locator provides a correct location, even when a user has provided the other authentication factors. The authentication system 200 thus provides added data security against an unauthorized user who moves the computing system 100 outside an approved geographic location.

The embodiments described herein may include various operations. These operations may be performed by hardware components, software, firmware, or a combination thereof. As used herein, the term “coupled to” may mean coupled directly or indirectly through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product that may include instructions stored on a non-transitory computer-readable medium. These instructions may be used to program a general-purpose or special-purpose processor to perform the described operations. A computer-readable medium includes any mechanism for storing or transmitting information in a form (e.g., software, processing application) readable by a machine (e.g., a computer). The non-transitory computer-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory, or another type of medium suitable for storing electronic instructions.

Additionally, some embodiments may be practiced in distributed computing environments where the computer-readable medium is stored on and/or executed by more than one computer system. In addition, the information transferred between computer systems may either be pulled or pushed across the transmission medium connecting the computer systems.

Generally, a data structure representing the authentication system 200 and/or portions thereof carried on the computer-readable storage medium may be a database or other data structure which can be read by a program and used, directly or indirectly, to fabricate the hardware comprising the authentication system 200. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the authentication system 200. The netlist may then be placed and routed to produce a data set describing geometric shapes to be applied to masks. The masks may then be used in various semiconductor fabrication steps to produce a semiconductor circuit or circuits corresponding to the authentication system 200. Alternatively, the database on the computer-readable storage medium may be the netlist (with or without the synthesis library) or the data set, as desired, or Graphic Data System (GDS) II data.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the embodiments have been described with reference to specific exemplary embodiments thereof. It will, however, be evident that various modifications and changes may be made thereto without departing from the broader spirit and scope of the embodiments as set forth in the appended claims. The specification and drawings are, accordingly, to be regarded in an illustrative sense rather than a restrictive sense.

What is claimed is:

1. A method of decrypting encrypted data in a device, comprising:
receiving one or more electrical signals indicating a present location of the device;
calculating location information for the device based on the received one or more electrical signals;
generating a first key based on the location information wherein a value of the first key depends on the present location of the device;
combining the first key with at least a second key to generate a combined key; and
decrypting the encrypted data based on the combined key.

2. The method of claim 1, further comprising:
storing the encrypted data in a memory of the device;
receiving a password from a user; and
generating the second key based on the password.

3. The method of claim 1, wherein combining the first key with the second key further comprises concatenating the first key with the second key.

4. The method of claim 1, wherein the one or more electrical signals are received by a global positioning system (GPS) locator attached to the device.

5. The method of claim 4, wherein the location information comprises a latitude value and a longitude value of the device.

6. The method of claim 1, further comprising determining the present location of the device by performing triangulation based on the one or more received electrical signals, wherein the one or more received electrical signals are received from a plurality of signal sources at known locations.

7. The method of claim 1, further comprising determining the present location of the device by identifying one or more other devices in a network coupled with the device, wherein each of the one or more other devices has a known location.

8. The method of claim 1, wherein generating the first key further comprises rounding one or more location values of the location information to generate one or more rounded location values.

9. The method of claim 8, wherein generating the first key further comprises salting at least one of the one or more rounded location values with a salt value to generate a salted location value.

10. The method of claim 9, generating the first key further comprises performing a cryptographic hash process on the salted location value to generate the first key.

11. A non-transitory computer-readable medium storing instructions that when executed by a processor cause the processor to perform a method of decrypting encrypted data in a device, the method comprising:
receiving one or more electrical signals indicating a present location of the device;
calculating location information for the device based on the received one or more electrical signals;
generating a first key based on the location information, wherein a value of the first key depends on the present location of the device;
combining the first key with at least a second key to generate a combined key; and
decrypting the encrypted data based on the combined key.

12. The non-transitory computer-readable medium of claim 11, wherein the method further comprises:
storing the encrypted data in a memory of the device;
receiving a password from a user; and
generating the second key based on the password, wherein combining the first key with the second key further comprises concatenating the first key with the second key.

13. The non-transitory computer-readable medium of claim 11, wherein the method further comprises:
receiving the one or more electrical signals via a global positioning system (GPS) locator attached to the device
wherein the location information comprises at least a latitude value and a longitude value of the device.

14. The non-transitory computer-readable medium of claim 11, wherein the method further comprises:
determining the present location of the device by identifying one or more other devices having a known physical location in a network coupled with the device.

15. The non-transitory computer-readable medium of claim 11, wherein generating the first key further comprises:
rounding one or more location values of the location information to generate one or more rounded location values;
salting at least one of the one or more rounded location values with a salt value to generate a salted location value; and
performing a cryptographic hash process on the salted location value.

16. An apparatus, comprising:
a cryptographic engine;
a memory coupled with the cryptographic engine, wherein the memory is configured to store encrypted data;
an input device coupled with the cryptographic engine, wherein the input device is configured to receive a first input value; and
a location detection module coupled with the cryptographic engine, wherein the location detection module is configured to calculate location information for the device based on receiving one or more electrical signals indicating a present location of the device, and wherein the cryptographic engine is configured to generate a second key based on the location information, and is further configured to decrypt the encrypted data based on a first key based on the first input value and the second key, wherein a value of the first key depends on the present location of the device.

17. The apparatus of claim 16, wherein the input device comprises a keyboard configured to receive a password as the first input value, and wherein the cryptographic engine is configured to generate the second key based on the password.

18. The apparatus of claim 16, wherein the location detection module comprises a global positioning system (GPS) locator configured to determine a latitude and longitude of the apparatus, and wherein the location information comprises the latitude and longitude.

19. The apparatus of claim 16, wherein the location detection module comprises a network adapter configured to determine identifying information for one or more other devices in a network coupled with the network adapter, wherein the location information comprises the identifying information.

20. The apparatus of claim 16, further comprising:
a rounding module coupled with the location detection module, wherein the rounding module is configured to round one or more location values of the location information to generate one or more rounded location values;
a salting module coupled with the rounding module, wherein the salting module is configured to salt at least one of the one or more rounded location values with a salt value to generate a salted location value; and
a hash engine coupled with the salting module and the cryptographic engine, wherein the hash engine is configured to perform a cryptographic hash process on the salted location value to generate the first key.
